(19) United States
(12) Patent Application Publication
(10) Pub. No.: US 2007/0254627 A1
(43) Pub. Date: Nov. 1, 2007

(54) Receiving operation control device, receiving operation control method, and computer-readable storage medium

(75) Inventors: Yoshiaki Kikuchi, Kawasaki (JP); Tohru Ida, Kawasaki (JP); Yuko Nakajima, Kawasaki (JP); Masami Eto, Kawasaki (JP); Makoto Nakano, Kawasaki (JP); Takayuki Ebara, Kawasaki (JP); Katsuaki Akama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/543,903

(22) Filed: Oct. 6, 2006

(30) Foreign Application Priority Data
Apr. 28, 2006 (JP) 2006-126022

(51) Int. Cl. H04M 11/04

(52) U.S. Cl. 455/404.2

(57) ABSTRACT

A call-termination operation control device that controls the volume of a call termination sound or the magnitude of vibration of a vibrator for the purpose of informing a user of a mobile communication equipment of the fact that a call has been terminated includes a moving state and receiving operation pattern registration unit in which combinations of positioning detection patterns and vibration detection patterns detected by a positioning sensor and a vibration sensor are recorded, moving states associated with the combinations are registered, and receiving operation patterns associated with the moving states are registered; a moving state decision unit that decides the moving state on the basis of the positioning detection pattern and vibration detection pattern which are detected at the time of call termination; a receiving operation pattern selection unit that selects a receiving operation pattern associated with the moving state according to the result of the decision; and a volume of call termination sound/magnitude of vibration designation unit that designates the volume of a call termination sound and the magnitude of vibration, which are associated with the receiving operation pattern, according to the result of the selection. Also disclosed are a receiving operation control method for controlling the volume of a call termination sound or the magnitude of vibration as mentioned above.

### BACKGROUND OF THE INVENTION

1. Field of the Invention

The present invention relates to a receiving operation control device (or a call termination operation control device) and the receiving operation control method that appropriately control the volume of a call termination sound and the magnitude of vibration of a vibrator or the like, so as to perform a receiving operation for the purpose of informing a user of a mobile communication equipment, such as a portable cellular phone or a handheld device, of the fact that a call has been terminated (i.e., the fact that a call has been received). The present invention also relates to computer-readable storage medium for storing a program for implementing the above method.

2. Description of the Related Art

In general, a mobile communication equipment, such as a portable cellular phone or a handheld device, that adopts a wideband code division multiple access (W-CDMA) technique, has been designed so that a user of the mobile communication equipment designates in advance the volume of a call termination sound to be generated at the time of call termination, the kind of call termination sound, or the magnitude of vibration to be caused by a vibrator in a manner mode or silent mode. When a call is terminated at the thus designed mobile communication equipment, a call termination sound is generated or a vibrator is operated according to the volume of a call termination sound, the kind of call termination sound, or the magnitude of vibration of the vibrator, which has been designated in advance. Thus, the user is informed of the fact that a call has been terminated.

However, as far as a conventional mobile communication equipment is concerned, the volume of a call termination sound, the kind of call termination sound, or the magnitude of vibration of a vibrator is designated in advance, irrespective of whatever situation the user of the mobile communication equipment is in at the time of call termination. Consequently, assuming that the user of the mobile communication equipment is moving (for example, the user is walking or running), even if a call termination sound is generated or a vibrator is operated in order to inform the user of the fact that a call has been terminated, the user may be unaware of the call termination sound or the vibration of the vibrator, due to ambient vibration or noise near the mobile communication equipment.

For reference, Patent Documents No. 1 to No. 3, relevant to the conventional mobile communication equipment as in the foregoing, are listed below.

(1) Patent Document No. 1: Japanese Unexamined Patent (Kokai) Publication No. 5-136727

(2) Patent Document No. 2: Japanese Unexamined Patent (Kokai) Publication No. 9-191333

(3) Patent Document No. 3: Japanese Unexamined Patent (Kokai) Publication No. 2004-72313

Patent Document No. 1 disclosed a configuration of a mobile communication terminal that autonomously selects one of a plurality of call termination notification methods, which are designated in advance, according to the situation of the movement of the mobile communication terminal per se.

Patent Document No. 2 disclosed the configuration of an individual selection paging receiver that is capable of discriminating between vibration of a vibrator generated by a call termination and ambient vibration, even in a place in which the ambient vibration is conveyed from an ambient environment, as long as a vibration detection pattern different from the pattern of the ambient vibration is designated as the vibration of the vibrator generated by the call termination.

Patent Document No. 3 disclosed the configuration of a mobile handheld device that is capable of autonomously switching the volume of sound, from a loudspeaker that is a notification means, or the on state and the off state of a vibrator or a telephone message recorder in the case in which the mobile handheld device enters a predefined range together with a user, or the mobile handheld device leaves the range.

However, none of Patent Documents No. 1 to No. 3 refer to a concrete technique for automatically deciding the moving state of a mobile communication equipment using a positioning sensor (for example, a global positioning system (GPS) sensor) incorporated in the mobile communication equipment and a vibration sensor in combination, and automatically designating the volume of a call termination sound or the magnitude of vibration of a vibrator according to the decided moving state. Consequently, the same problem, as in the aforesaid conventional mobile communication equipment, may occur in each equipment described in Patent Documents No. 1 to No. 3.

### SUMMARY OF THE INVENTION

The present invention has been conceived of in order to overcome the foregoing problem. An object of the present invention is to provide a receiving operation control device (or a call termination operation control device) that is capable of autonomously deciding the moving state of a mobile communication equipment at the time of call termination, and designating the volume of a call termination sound or the magnitude of vibration of a vibrator according to the decided moving state, a receiving operation control method, and a computer-readable storage medium for storing a program for implementing the receiving operation control method.

To attain the above object, a receiving operation control device in accordance with one aspect of the present invention includes a moving state and receiving operation pattern registration unit in which combination patterns of positioning detection patterns relevant to positions of a mobile communication equipment that may be detected by a positioning sensor incorporated in the mobile communication equipment and vibration detection patterns relevant to levels of vibration that may be detected by a vibration sensor incorporated in the mobile communication equipment are recorded, moving states of the mobile communication equipment associated with the combination patterns are registered in advance, and receiving operation patterns associated with the moving states are registered in advance; a moving state decision unit that, when a call is terminated (i.e., when a call is received) at the mobile communication equipment, decides a moving state of the mobile communication equipment on the basis of the positioning detection pattern and vibration detection pattern detected by the positioning sensor and vibration sensor, respectively: a receiving operation pattern selection unit that selects a receiving operation pattern, which is associated with the moving state, from among the patterns registered in the moving state and receiving operation pattern registration unit according to the result of the decision made by the moving state decision unit; and a volume of call termination sound/magnitude of vibration designation unit that designates at least one of the volume of a call termination sound to be generated by the mobile communication equipment and the magnitude of vibration, which are associated with the receiving operation pattern, according to the result of the selection performed by the receiving operation pattern selection unit.

Furthermore, a receiving operation control device in accordance with another aspect of the present invention includes a moving state and receiving operation pattern registration unit in which combination patterns of positioning detection patterns relevant to positions of a mobile communication equipment that may be detected by a positioning sensor incorporated in the mobile communication equipment and vibration detection patterns relevant to levels of vibration that may be detected by a vibration sensor incorporated in the mobile communication equipment are recorded, moving states of the mobile communication equipment associated with the combination patterns are registered in advance, and receiving operation patterns associated with the moving states are registered in advance; a moving state decision unit that decides a moving state of the mobile communication equipment on the basis of the positioning detection pattern and vibration detection pattern detected by the positioning sensor and vibration sensor, respectively, at intervals of a predetermined period; a receiving operation pattern selection unit that, when a call is terminated at the mobile communication equipment, selects a receiving operation pattern, which is associated with the moving state, from among the patterns registered in the moving state and receiving operation pattern registration unit according to the result of the decision made by the moving state decision unit; and a volume of call termination sound/magnitude of vibration designation unit that designates at least one of the volume of a call termination sound to be generated by the mobile communication equipment and the magnitude of vibration, which are associated with the receiving operation pattern, according to the result of the selection performed by the receiving operation pattern selection unit.

On the other hand, a receiving operation control method in accordance with one aspect of the present invention includes the step of, when the volume of a call termination sound to be generated by a mobile communication equipment and the magnitude of vibration are controlled in order to perform a receiving operation, recording combination patterns of positioning detection patterns relevant to the positions of the mobile communication equipment that may be detected by a positioning sensor incorporated in the mobile communication equipment and vibration detection patterns relevant to levels of vibration that may be detected by a vibration sensor incorporated in the mobile communication equipment, registering in advance moving states of the mobile communication equipment associated with the combination patterns, and registering in advance receiving operation patterns associated with the moving states; the step of, when a call is terminated at the mobile communication equipment, deciding the moving state of the mobile communication equipment on the basis of the positioning detection pattern and vibration detection pattern detected by the positioning sensor and vibration sensor, respectively; the step of selecting a receiving operation pattern associated with the moving state according to the result of the decision of the moving state; and the step of designating at least one of the volume of a call termination sound to be generated by the mobile communication equipment and the magnitude of vibration, which are associated with the receiving operation pattern, according to the result of the selection of the receiving operation pattern.

Furthermore, a receiving operation control method in accordance with another aspect of the present invention includes the step of recording combination patterns of positioning detection patterns relevant to positions of a mobile communication equipment that may be detected by a positioning sensor incorporated in the mobile communication equipment and vibration detection patterns relevant to levels of vibration that may be detected by a vibration sensor incorporated in the mobile communication equipment, registering in advance moving states of the mobile communication equipment associated with the combination patterns, and registering in advance receiving operation patterns associated with the moving states; the step of deciding a moving state of the mobile communication equipment on the basis of the positioning detection pattern and vibration detection pattern detected by the positioning sensor and vibration sensor, respectively, at intervals of a predetermined period; a step of, when a call is terminated at the mobile communication equipment, selecting a receiving operation pattern associated with the moving state according to the result of the decision of the moving state; and a step of designating at least one of the volume of a call termination sound to be generated by the mobile communication equipment and the magnitude of vibration, which are associated with the receiving operation pattern, according to the result of the selection of the receiving operation pattern.

On the other hand, the present invention provides a computer-readable storage medium for storing a program that, assuming that moving states of a mobile communication equipment associated with combination patterns of positioning detection patterns relevant to the positions of the mobile communication equipment that may be detected by a positioning sensor incorporated in the mobile communication equipment and vibration detection patterns relevant to levels of vibration that may be detected by a vibration sensor incorporated in the mobile communication equipment are registered in advance, and receiving operation patterns associated with the moving states are registered in advance, allows a computer to decide the moving state of the mobile communication equipment on the basis of the positioning detection pattern and vibration detection pattern detected by the positioning sensor and vibration sensor, respectively, when a call is terminated at the mobile communication equipment; to select a receiving operation pattern associated with the moving state according to the result of the decision of the moving state; and to designate at least one of the volume of a call termination sound to be generated by the mobile communication equipment and the magnitude of vibration, which are associated with the receiving operation pattern, according to the result of the selection of the receiving operation pattern.

In short, according to the present invention, first, combination patterns of positioning detection patterns and vibration detection patterns which may be detected by a positioning sensor and vibration sensor, respectively, incorporated in the mobile communication equipment are recorded, and receiving operation patterns associated with the combination patterns are registered in advance. When a call is terminated, the moving state of the mobile communication equipment is decided based on the positioning detection pattern and vibration detection pattern detected by the positioning sensor and vibration sensor, respectively. Furthermore, either or both of the volume of a call termination sound and the magnitude of vibration are designated based on a receiving operation pattern selected in association with the decided moving state.

Consequently, according to the above-mentioned first technique, in which the present invention is implemented, a moving state of mobile communication equipment is automatically decided based on a positioning detection pattern and a vibration detection pattern detected by a positioning sensor and a vibration sensor incorporated in the mobile communication equipment. Moreover, the volume of a call termination sound and the magnitude of vibration of a vibrator are automatically selected based on the decided moving state. A receiving operation for call termination can then be performed. Even when ambient vibration or ambient noise is large, a disadvantageous event in which a user who is moving is unaware of the call termination sound or the vibration of the vibrator will not take place.

On the other hand, according to the present invention, second, combination patterns of positioning detection patterns and vibration detection patterns that may be detected by a positioning sensor and a vibration sensor, respectively, incorporated in the mobile communication equipment are recorded, and receiving operation patterns associated with the combination patterns are registered in advance. A moving state of the mobile communication equipment is cyclically decided based on the positioning detection pattern and vibration detection pattern, which are detected by the positioning sensor and vibration sensor, respectively, at intervals of a predetermined period. When a call is terminated, either or both of the volume of a call termination sound and the magnitude of vibration of a vibrator that are selected based on the result of the cyclic decision of the moving state of the mobile communication equipment are designated.

Consequently, according to the above-mentioned second technique in which the present invention is implemented, the volume of a call termination sound and the magnitude of vibration of a vibrator are automatically selected based on the moving state of the mobile communication equipment decided cyclically on the basis of the positioning detection pattern and vibration detection pattern which are detected by the positioning sensor and vibration sensor, respectively, incorporated in the mobile communication equipment. A receiving operation for call termination is then performed. Similarly to the aforesaid first technique, a disadvantageous event in which a user who is moving is unaware of the call termination sound or the vibration of the vibrator will not take place. Furthermore, according to the second technique, as the moving state of the mobile communication equipment is decided before a call is terminated, a speed at which volumes of a call termination sound or magnitudes of vibration of the vibrator are switched at the time of call termination is higher than that attained according to the first technique.

### BRIEF DESCRIPTION OF THE DRAWINGS

The above object and features of the present invention will be more apparent from the following description of some preferred embodiments with reference to the accompanying drawings, wherein;

FIG. 1 is a block diagram showing the configuration of a receiving operation control device in accordance with an embodiment of the present invention;

FIG. 2 is a block diagram showing the configuration of a computer system including the receiving operation control device shown in FIG. 1;

FIG. 3 shows a data format adapted to a concrete example of a moving state registration table employed in the receiving operation control device shown in FIG. 1;

FIG. 4 shows a data format adapted to a concrete example of a receiving operation pattern registration table employed in the receiving operation control device shown in FIG. 1;

FIG. 5 is a flowchart describing a first receiving operation control flow in accordance with the present invention;

FIG. 6 is a flowchart describing a second receiving operation control flow in accordance with the present invention;

FIG. 7 is a flowchart describing a third receiving operation control flow in accordance with the present invention; and

FIG. 8 is a flowchart describing a fourth receiving operation control flow in accordance with the present invention.

### DESCRIPTION OF THE PREFERRED EMBODIMENTS

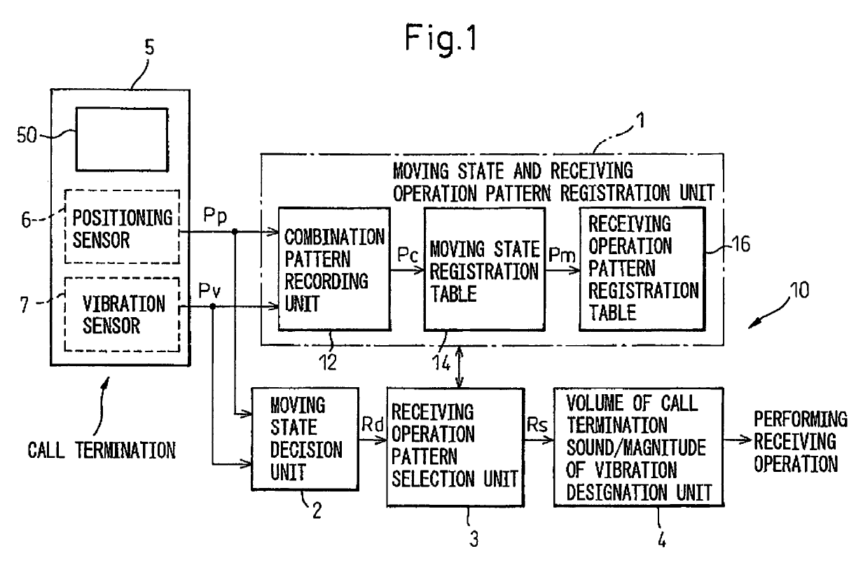

Referring to the appended drawings (FIG. 1 to FIG. 8), constituent features of some preferred embodiments of the present invention, and operations to be performed in the embodiment, will be described below.

FIG. 1 is a block diagram showing the configuration of a receiving operation control device in accordance with an embodiment of the present invention. Herein, the configuration of a receiving operation control device 10 in accordance with the embodiment of the present invention is shown schematically. Hereinafter, the same reference numerals will be assigned to any components substantially identical to the aforesaid components.

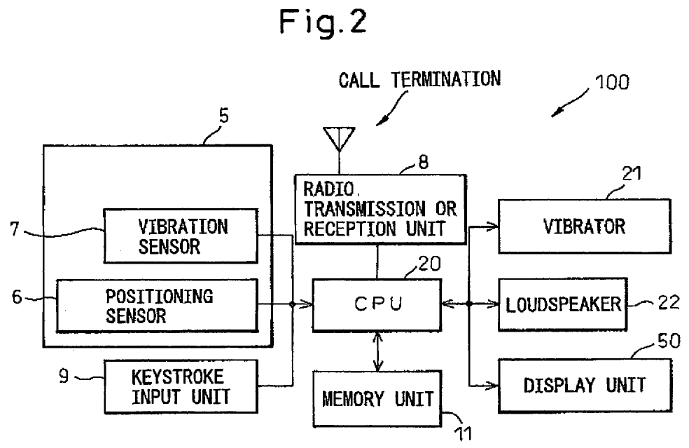

As shown in FIG. 1, a mobile communication equipment 5, such as a portable cellular phone or a handheld device, includes a display unit 50 on which data, entered through a keystroke input unit (for example, see FIG. 2 that will be mentioned below), is displayed or on which a progress of data transmission or reception is displayed.

Furthermore, the mobile communication equipment 5 includes a positioning sensor 6 and a vibration sensor 7. The positioning sensor 6 has the ability to detect a positioning detection pattern (Pp) by measuring the position of a user of the mobile communication equipment 5. Preferably, the positioning sensor 6 is realized with a global positioning system (GPS) sensor that identifies a latitude and a longitude, which represent the position of the user of the mobile communication equipment, by receiving radio waves from a plurality of orbiting satellites. More specifically, as the positioning detection pattern, a speed at which the mobile communication equipment or the user of the mobile communication equipment is moving may be calculated based on data items of a plurality of latitudes and longitudes identified by the GPS sensor at different time instants. On the other hand, the vibration sensor 7 has the ability to detect a vibration detection pattern (Pv) by measuring a level of vibration around the mobile communication equipment.

The receiving operation control device 10 in accordance with the embodiment shown in FIG. 1 has a moving state and receiving operation pattern registration unit 1 composed of memories such as a read-only memory (ROM) and a random access memory (RAM). The moving state and receiving operation pattern registration unit 1 includes a combination pattern recording unit 12 in which combination patterns (Pc) that are combinations of positioning detection patterns and vibration detection patterns which may be detected by the positioning sensor 6 and vibration sensor 7, respectively, are recorded; a moving state registration table 14 in which moving states of a user of the mobile communication equipment associated with the combination patterns recorded in the combination pattern recording unit 12 are registered in advance; and a receiving operation pattern registration table 16 in which receiving operation patterns (Pm) associated with the moving states of the user of the mobile communication equipment registered in the moving state registration table 14 are registered in advance.

Furthermore, the receiving operation control device 10 shown in FIG. 1 includes a moving state decision unit 2, a receiving operation pattern selection unit 3, and a volume of call termination sound/magnitude of vibration designation unit 4. Herein, the moving state decision unit 2 has the ability to decide the moving state of the user, or the like, of the mobile communication equipment 5 by referring to a positioning detection pattern and a vibration detection pattern, which are actually detected by the positioning sensor 6 and vibration sensor 7, respectively, when a call associated with incoming data is terminated at the mobile communication equipment 5 (when data is received by the mobile communication equipment). On the other hand, the receiving operation pattern selection unit 3 has the ability to select a receiving operation pattern, which is associated with the moving state of the user of the mobile communication equipment 5, from among all the patterns listed in the receiving operation pattern registration table 16 by referring to the result of the decision (Rd) made by the moving sate decision unit 2. On the other hand, the volume of call termination sound/magnitude of vibration designation unit 4 has the ability to designate either or both of the volume of a call termination sound to be generated by the mobile communication equipment 5 and the magnitude of vibration of a vibrator or the like, which are associated with the receiving operation pattern, by referencing the receiving operation pattern (Rs) selected by the receiving operation pattern selection unit 3. As mentioned later, the abilities of the moving state decision unit 2, receiving operation pattern selection unit 3, and volume of call termination sound/magnitude of vibration designation unit 4 are implemented in a computer or a central processing unit (CPU) included in a computer system.

A series of operations to be performed by the receiving operation control device 10 shown in FIG. 1 will be described briefly.

First, the combination pattern recording unit 12 included in the moving state and receiving operation pattern registration unit 1 estimates combinations of positioning detection patterns and vibration detection patterns, which may be detected by the positioning sensor 6 and vibration sensor 7, respectively, so as to record combination patterns. Moving states of a user of mobile communication equipment associated with the combination patterns recorded in the combination pattern recording unit 12 are registered, in advance, in the moving state registration table 14. Furthermore, receiving operation patterns associated with the moving states registered in the moving state registration table 14 are registered, in advance, in the receiving operation pattern registration table 16.

When a call is terminated at the mobile communication equipment 5, the moving state decision unit 2 decides the moving state of the user of the mobile communication equipment 5 on the basis of the positioning detection pattern and vibration detection pattern detected by the positioning sensor 6 and vibration sensor 7, respectively. Furthermore, the receiving operation pattern selection unit 3 selects a receiving operation pattern associated with the moving state of the user of the mobile communication equipment 5 according to the result of the decision made by the moving state decision unit 2. Finally, the volume of call termination sound/magnitude of vibration designation unit 4 designates the volume of a call termination sound to be generated by the mobile communication equipment 5 or the magnitude of vibration to be caused by a vibrator or the like, which are associated with the receiving operation pattern selected by the receiving operation pattern selection unit 3, and performs a receiving operation.

According to the embodiment shown in FIG. 1, the moving state of mobile communication equipment is automatically decided based on a positioning detection pattern and a vibration detection pattern detected by the positioning sensor and vibration sensor incorporated in the mobile communication equipment. Based on the decided, moving state, the volume of a call termination sound or the magnitude of vibration of a vibrator or the like is automatically selected, and a receiving operation for call termination is performed. Consequently, an event in which the user who is moving is unaware of the call termination sound or the vibration of the vibrator or the like can be avoided.

Furthermore, as an alternative to the embodiment shown in FIG. 1, a positioning detection pattern and a vibration detection pattern detected by the positioning sensor 6 and vibration sensor 7, respectively, at intervals of a certain period may be substituted for a positioning detection pattern and a vibration detection pattern, which are detected by the positioning sensor 6 and vibration sensor 7, respectively, when a call is terminated at the mobile communication equipment 5. Based on the positioning detection pattern and vibration detection pattern detected at intervals of the certain period, the moving state of the mobile communication equipment 5 may be decided cyclically. In this case, when a call is terminated at the mobile communication equipment 5, the volume of a call termination sound or the magnitude of vibration of a vibrator which is selected based on the result of the cyclic decision of the moving state of the mobile communication equipment 5 is designated.

According to the foregoing alternative, the moving state of mobile communication equipment is cyclically decided before a call is terminated at the mobile communication equipment. Therefore, a speed at which volumes of a call termination sound or magnitudes of vibration of a vibrator are switched at the time of call termination is higher than that attained in the embodiment shown in FIG. 1.

FIG. 2 is a block diagram showing the configuration of a computer system including the receiving operation control device shown in FIG. 1. Herein, the hardware configuration of a computer system 100 including the receiving operation control device shown in FIG. 1 is schematically shown on the assumption that the computer system 100 is applied to the mobile communication equipment 5, such as a portable cellular phone or a handheld device. The components of the computer system are actually incorporated in the mobile communication equipment 5. However, for convenience' sake, components other than the positioning sensor 6 and vibration sensor 7 are shown as if they were external to the mobile communication equipment 5.

The computer system 100 shown in FIG. 2 includes a radio transmission or reception unit 8 that transmits or receives a high-frequency signal by utilizing the W-CDMA technique; a CPU 20 that performs various kinds of computation on data contained in the high-frequency signal sent from the radio transmission or reception unit 8, or that treats data which a user enters by manipulating a keystroke input unit 9; and a memory unit 11 in which various data items including various programs (various kinds of software) needed to execute a receiving operation control flow in accordance with the present invention are stored. The memory unit 11 includes a ROM and a RAM. Alternatively, a ROM and a RAM incorporated in the CPU 20 may be substituted for the memory unit 11.

Furthermore, the computer system shown in FIG. 2 includes a vibrator 21 that vibrates the mobile communication equipment 5 so as to inform a user or the like of the fact that a call has been terminated, a loudspeaker 22 that emits a call termination sound so as to inform the user or the like of the fact that a call has been terminated, and a display unit 50 similar to the one shown in FIG. 1.

Preferably, the functions of the moving state decision unit 2, receiving operation pattern selection unit 3, and volume of call termination sound/magnitude of vibration designation unit 4 shown in FIG. 1 are implemented in the CPU 20 shown in FIG. 2. More particularly, the CPU 20 reads receiving operation control programs stored in the ROM or the like included in the memory unit 11 shown in FIG. 2, and various kinds of data items needed to run the programs and stored in the RAM, and runs the programs. Consequently, features equivalent to the moving state decision unit 2, receiving operation pattern selection unit 3, and volume of call termination sound/magnitude of vibration designation unit 4 are realized.

As the CPU 20 operates as mentioned above, when a call is terminated at a mobile communication equipment, the CPU 20 decides the moving state of a user or the like on the basis of a combination pattern of a positioning detection pattern and a vibration detection pattern. Furthermore, the CPU 20 can appropriately control either or both of the volume of sound emitted by the loudspeaker 22 and the magnitude of vibration caused by the vibrator 21 according to a receiving operation pattern selected in association with the decided moving state.

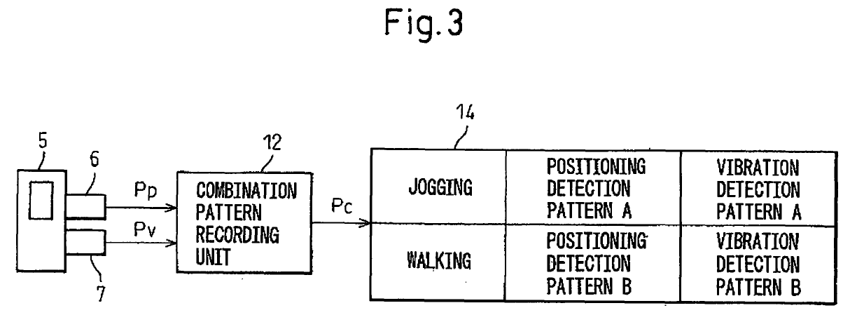

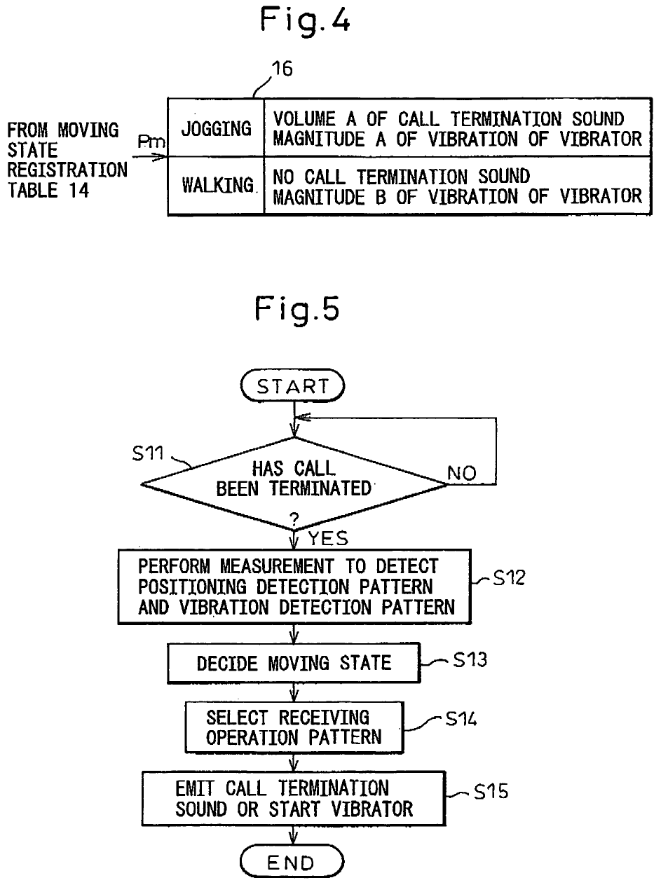

FIG. 3 shows a data format adapted to a concrete example of a moving state registration table shown in FIG. 1. FIG. 4 shows a data format adapted to a concrete example of a receiving operation pattern registration table shown in FIG. 1.

As mentioned above, combination patterns that are combinations of positioning detection patterns (Pp) and vibration detection patterns (Pv) which may be detected by the positioning sensor 6 and vibration sensor 7, respectively, incorporated in the mobile communication equipment 5 are recorded in the combination pattern recording unit 12. Furthermore, moving states of a user or the like associated with the combination patterns (Pc) recorded in the combination pattern recording unit 12 are registered in the moving state registration table 14.

In the concrete example of the moving state registration table 14 shown in FIG. 3, a combination pattern that is a combination of a positioning detection pattern and a vibration detection pattern is registered in association with each of two moving states of a user of the mobile communication equipment 5 that are “jogging” and “walking.” For example, assuming that the user is “jogging,” a combination pattern that is a combination of a positioning detection pattern A and a vibration detection pattern A is registered. Assuming that the user is “walking,” a combination pattern that is a combination of a positioning detection pattern B and a vibration detection pattern B is registered.

Herein, when the user is “jogging,” a moving speed at which the mobile communication equipment (or the user of the mobile communication equipment) is moving is higher than that attained when the user is “walking.” Moreover, a level of ambient vibration is larger than that generated when the user is “walking”. Consequently, the moving speed of the mobile communication equipment indicated by the positioning detection pattern A is higher than the moving speed thereof indicated by the positioning detection pattern B. The level of ambient vibration indicated by the vibration detection pattern A is larger than the level of ambient vibration indicated by the vibration detection pattern B. Incidentally, the moving states of the user to be listed in the moving state registration table 14 are not limited to the foregoing two moving states, but other many moving states are conceivable. For example, when the user (driver) is “running (driving),” the moving speed of the mobile communication equipment (or the user of the mobile communication equipment) is higher than that attained when the user is “jogging.” Moreover, a level of ambient vibration is remarkably large.

In the concrete example of the receiving operation pattern registration table 16 shown in FIG. 4, a receiving operation pattern is registered in association with each of two moving states of a user of mobile communication equipment that are “jogging” and “walking.” For example, when the user is “jogging,” as the level of ambient vibration is relatively large, the volume of a call termination sound to be generated by the mobile communication equipment is set to a large value (volume A of a call termination sound), and the magnitude of vibration to be caused by the vibrator is set to a large value (magnitude A of vibration by the vibrator). On the other hand, when the user is “walking,” as the level of ambient vibration is relatively small, the volume of a call termination sound to be generated by the mobile communication equipment is set to 0 (zero) (no call termination sound). However, the magnitude of vibration to be caused by the vibrator is set to a value smaller than the value associated with “jogging” but larger than the value associated with a case in which a user is “stationary” (magnitude B of vibration of the vibrator). When the user (driver) is running (driving), as the level of ambient vibration is remarkably large, the volume of a call termination sound to be generated by the mobile communication equipment is set to a nearly maximum value and the magnitude of vibration of the vibrator is set to a nearly maximum value.

FIG. 5 is a flowchart describing a first receiving operation control flow in accordance with the present invention. Herein, a description will be made of a flow of processing in which the CPU (see FIG. 2) included in the receiving operation control device is started in order to designate the volume of a call termination sound or the magnitude of vibration of the vibrator according to the moving state of a user of a mobile communication equipment. In this case, the moving state and receiving operation pattern registration unit (see FIG. 2) included in the receiving operation control device registers, in advance, moving states of a user of a mobile communication equipment associated with combination patterns of positioning detection patterns and vibration detection patterns, and registers, in advance, receiving operation patterns associated with the moving states of the user of the mobile communication equipment registered in the moving state registration table.

First, if a call has been terminated at the mobile communication equipment at step S11, the positioning sensor incorporated in the mobile communication equipment measures the position of the user of the mobile communication equipment and detects a positioning detection pattern at step S12. On the other hand, the vibration sensor incorporated in the mobile communication equipment measures a level of ambient vibration of the mobile communication equipment and detects a vibration detection pattern.

Thereafter, at step S13, the moving state of the user of the mobile communication equipment is decided based on the positioning detection pattern and vibration detection pattern detected by the positioning sensor and vibration sensor, respectively.

At step S14, a receiving operation pattern associated with the moving state of the user is selected from among the patterns registered in the moving state and receiving operation pattern registration unit according to the result of the decision of the moving state of the user of the mobile communication equipment.

At step S15, the volume of a call termination sound or the magnitude of vibration of the vibrator or the like associated with the receiving operation pattern selected from among the patterns registered in the moving state and receiving operation pattern registration unit is designated. Based on the thus designated volume of a call termination sound or the magnitude of vibration of the vibrator or the like, a call termination sound is emitted or the vibrator is started (or vibrated). Thus, an appropriate receiving operation is performed for the mobile communication equipment.

According to the flowchart of FIG. 5, the CPU decides the moving state of a user of mobile communication equipment using the abilities of the positioning sensor and vibration sensor incorporated in the mobile communication equipment. The volume of a call termination sound or the magnitude of vibration of the vibrator or the like is designated according to the decided moving state. Consequently, an appropriate receiving operation can be performed. An event in which the user who is moving is unaware of the call termination sound or the vibration of the vibrator or the like can be avoided.

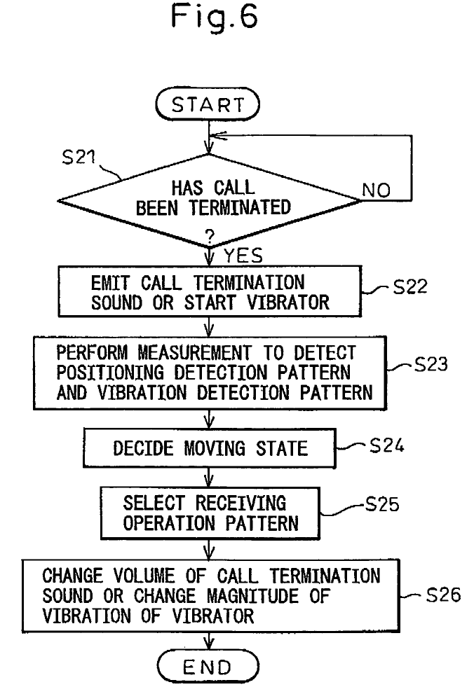

FIG. 6 is a flowchart describing a second receiving operation control flow in accordance with the present invention. Herein, a description will be made of a flow of processing in which the CPU (see FIG. 2) included in the receiving operation control device is started in order to change the previously designated volume of a call termination sound or the previously designated magnitude of vibration of a vibrator according to the moving state of a user of a mobile communication equipment.

First, if a call has been terminated at mobile communication equipment at step S21, a call termination sound is emitted and the vibrator is started, at step S22, according to the volume of a call termination sound or the magnitude of vibration of the vibrator which is designated according to the receiving operation control flow described in FIG. 5.

Thereafter, at step S23, the positioning sensor incorporated in the mobile communication equipment remeasures the position of the user of the mobile communication equipment so as to detect a new positioning detection pattern. On the other hand, the vibration sensor incorporated in the mobile communication equipment remeasures the level of ambient vibration of the mobile communication equipment so as to detect a new vibration detection pattern.

Thereafter, at step S24, the moving state of the user of the mobile communication equipment is decided again based on the new positioning detection pattern and vibration detection pattern detected by the positioning sensor and vibration sensor, respectively.

Furthermore, at step S25, based on the result of the above decision of the moving state of the user of the mobile communication equipment, a receiving pattern associated with the moving state of the user is selected from among the patterns registered in the moving state and receiving operation pattern registration unit.

Furthermore, at step S26, the previously designated volume of a call termination sound or the previously designated magnitude of vibration of the vibrator or the like is changed based on the receiving operation pattern selected from among the patterns registered in the moving state and receiving operation pattern registration unit. A call termination sound is emitted or the vibrator is started based on the thus changed volume of a call termination sound or the thus changed magnitude of vibration of the vibrator or the like, whereby a receiving operation is performed after the change of the setting of the mobile communication equipment.

According to the flowchart of FIG. 6, the CPU decides again the moving state of a user of a mobile communication equipment by utilizing the abilities of the positioning sensor and vibration sensor incorporated in the mobile communication equipment. The previously designated volume of a call termination sound or the previously designated magnitude of vibration of a vibrator or the like can be appropriately changed according to the newly decided moving state.

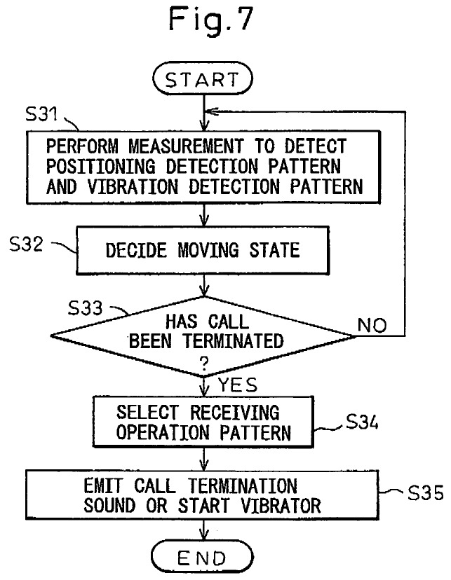

FIG. 7 is a flowchart describing a third receiving operation control flow in accordance with the present invention. Similarly to the flowcharts of FIG. 5 and FIG. 6, the flowchart of FIG. 7 describes a flow of processing in which a CPU (see FIG. 2) included in a receiving operation control device is started in order to designate the volume or a call termination sound or the magnitude of vibration of a vibrator according to the moving state of a user of a mobile communication equipment. Even in this case, similarly to the cases described in the flowcharts of FIG. 5 and FIG. 6, the moving state and receiving operation pattern registration unit (see FIG. 2) included in the receiving operation control device can register, in advance, the moving states of the user of the mobile communication equipment associated with combination patterns of positioning detection patterns and vibration detection patterns, and can register, in advance, receiving operation patterns associated with the moving states of the user of the mobile communication equipment registered in the moving state registration table.

First, at step S31, the positioning sensor incorporated in the mobile communication equipment measures the position of the user of the mobile communication equipment at intervals of a certain period, and cyclically detects a positioning detection pattern. On the other hand, the vibration sensor incorporated in the mobile communication equipment measures a level of ambient vibration of the mobile communication equipment at intervals of the certain period, and cyclically detects a vibration detection pattern.

Thereafter, at step S32, the moving state of the user of the mobile communication equipment is cyclically decided based on the positioning detection pattern and vibration detection pattern which are cyclically detected by the positioning sensor and vibration sensor, respectively.

Furthermore, if a call has been terminated at the mobile communication equipment at step S33, a receiving operation pattern associated with the moving state of the user is selected from among the patterns registered in the moving state and receiving operation pattern registration unit according to the result of the cyclic decision of the moving state of the user of the mobile communication equipment at step S34.

Furthermore, at step S35, the volume of a call termination sound or the magnitude of vibration of a vibrator or the like associated with the receiving operation pattern selected from among the patterns registered in the moving state and receiving operation pattern registration unit is designated. Based on the thus designated volume of a call termination sound or the thus designated magnitude of vibration of the vibrator or the like, a call termination sound is emitted or the vibrator is started. Thus, an appropriate receiving operation is performed for the mobile communication equipment.

According to the flowchart of FIG. 7, the moving state of the mobile communication equipment is cyclically decided before a call is terminated at the mobile communication equipment. Consequently, a speed at which volumes of a call termination sound to be generated at the time of a call termination or magnitudes of vibration to be caused by a vibrator are switched is higher than that attained in the case in which the receiving operation control flow described in FIG. 5 or FIG. 6 is applied.

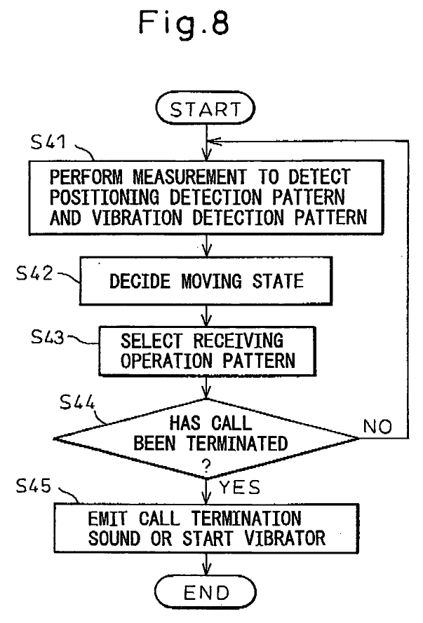

FIG. 8 is a flowchart describing a fourth receiving operation control flow in accordance with the present invention. Herein, a variant of the receiving operation control flow described in FIG. 7 will be described.

First, at step S41, a positioning sensor incorporated in mobile communication equipment measures the position of the user of the mobile communication equipment at intervals of a certain period, and cyclically detects a positioning detection pattern. On the other hand, a vibration sensor incorporated in the mobile communication equipment measures a level of ambient vibration of the mobile communication equipment at intervals of the certain period, and cyclically detects a vibration detection pattern. The contents of processing of step S41 are substantially identical to the contents of processing of step S31 described in the flowchart of FIG. 7.

Thereafter, at step S42, the moving state of the user of the mobile communication equipment is cyclically decided based on the positioning detection pattern and vibration detection pattern cyclically detected by the positioning sensor and vibration sensor, respectively. The contents of processing of step S42 are substantially identical to the contents of processing of step S32 described in the flowchart of FIG. 7.

Furthermore, at step S43, before a call is terminated at the mobile communication equipment, a receiving operation pattern associated with the moving state of the user is selected from among the patterns registered in the moving state and receiving pattern registration unit according to the result of the cyclic decision of the moving state of the user of the mobile communication equipment.

Furthermore, if a call has been terminated at the mobile communication equipment at step S44, the volume of a call termination sound or the magnitude of vibration of a vibrator or the like associated with the receiving operation pattern which is already selected before the call is terminated is immediately designated at step S45. Based on the thus designated volume of a call termination sound or the thus designated magnitude of vibration of the vibrator or the like, a call termination sound is emitted or the vibrator is started. Thus, an appropriate receiving operation is performed for the mobile communication equipment.

According to the flowchart of FIG. 8, before a call is terminated at mobile communication equipment, the moving state of the mobile communication equipment is cyclically decided. Furthermore, a receiving operation pattern associated with the moving state of the user is selected in advance according to the decided moving state. Consequently, a speed at which volumes of call termination sound to be generated at the time of call termination or magnitudes of vibration to be caused by the vibrator are switched is higher than that attained in the case in which the receiving operation control flow described in FIG. 7 is applied.

With regard to an industrial applicability of the present invention, the present invention is applicable to a portable cellular phone, a handheld device, or any other mobile communication equipment that adopts the W-CDMA technique, which, when a call is terminated, autonomously decides the moving state of mobile communication equipment on the basis of a positioning detection pattern and a vibration detection pattern detected by a positioning sensor and a vibration sensor, respectively, incorporated in the mobile communication equipment, and which autonomously designates the volume of a call termination sound or the magnitude of vibration of a vibrator associated with a receiving operation pattern selected in association with the moving state.

1. A receiving operation control device comprising:
a moving state and receiving operation pattern registration unit in which combination patterns of positioning detection patterns relevant to positions of a mobile communication equipment detected by a positioning sensor incorporated in the mobile communication equipment and vibration detection patterns relevant to levels of vibration detected by a vibration sensor incorporated in the mobile communication equipment are recorded, moving states of the mobile communication equipment associated with the combination patterns are registered in advance, and receiving operation patterns associated with the moving states are registered in advance;
a moving state decision unit that, when a call is terminated at the mobile communication equipment, decides the moving state of the mobile communication equipment on the basis of the positioning detection pattern and vibration detection pattern detected by the positioning sensor and vibration sensor, respectively;
a receiving operation pattern selection unit that selects a receiving operation pattern associated with the moving state from among the patterns, which are registered in the moving state and receiving operation pattern registration unit, according to the result of the decision made by the moving state decision unit; and
a volume of call termination sound/magnitude of vibration designation unit that designates at least one of the volume of a call termination sound to be generated by the mobile communication equipment and the magnitude of vibration, which are associated with the receiving operation pattern, according to the result of the selection performed by the receiving operation pattern selection unit.

2. The receiving operation control device according to claim 1, wherein a moving speed at which the mobile communication equipment moves is calculated based on a plurality of positioning detection patterns detected by the positioning sensor at different time instants.

3. A receiving operation control device comprising:
a moving state and receiving operation pattern registration unit in which combination patterns of positioning detection patterns relevant to positions of a mobile communication equipment detected by a positioning sensor incorporated in the mobile communication equipment and vibration detection patterns relevant to levels of vibration detected by a vibration sensor incorporated in the mobile communication equipment are recorded, moving states of the mobile communication equipment associated with the combination patterns are registered in advance, and receiving operation patterns associated with the moving states are registered in advance;
a moving state decision unit that decides the moving state of the mobile communication equipment on the basis of the positioning detection pattern and vibration detection pattern detected by the positioning sensor and vibration sensor, respectively, at intervals of a predetermined period;
a receiving operation pattern selection unit that, when a call is terminated at the mobile communication equipment, selects a receiving operation pattern associated with the moving state from among the patterns, which are registered in the moving state and receiving operation pattern registration unit, according to the result of the decision made by the moving state decision unit; and
a volume of call termination sound/magnitude of vibration designation unit that designates at least one of the volume of a call termination sound to be generated by the mobile communication equipment and the magnitude of vibration, which are associated with the receiving operation pattern, according to the result of the selection performed by the receiving operation pattern selection unit.

4. The receiving operation control device according to claim 3, wherein a moving speed at which the mobile communication equipment moves is calculated based on a plurality of positioning detection patterns detected by the positioning sensor at different time instants.

5. A receiving operation control method for controlling the volume of a call termination sound to be generated by a mobile communication equipment and the magnitude of vibration so as to perform a receiving operation, comprising the steps of:
recording combination patterns of positioning detection patterns relevant to positions of the mobile communication equipment detected by a positioning sensor incorporated in the mobile communication equipment and vibration detection patterns relevant to levels of vibration detected by a vibration sensor incorporated in the mobile communication equipment, registering in advance moving states of the mobile communication equipment associated with the combination patterns, and registering in advance receiving operation patterns associated with the moving states;
when a call is terminated at the mobile communication equipment, deciding the moving state of the mobile communication equipment on the basis of the positioning detection pattern and vibration detection pattern detected by the positioning sensor and vibration sensor, respectively;
selecting a receiving operation pattern associated with the moving state according to the result of the decision of the moving state; and
designating at least one of the volume of a call termination sound to be generated by the mobile communication equipment and the magnitude of vibration, which are associated with the receiving operation pattern, according to the result of the selection of the receiving operation pattern.

6. The receiving operation control method according to claim 5, wherein a moving speed at which the mobile communication equipment moves is calculated based on a plurality of positioning detection patterns detected by the positioning sensor at different time instants.

7. A receiving operation control method for controlling the volume of a call termination sound to be generated by a mobile communication equipment and the magnitude of vibration so as to perform a receiving operation, comprising the steps of:
recording combination patterns of positioning detection patterns relevant to positions of the mobile communication equipment detected by a positioning sensor incorporated in the mobile communication equipment and vibration detection patterns relevant to levels of vibration detected by a vibration sensor incorporated in the mobile communication equipment, registering in advance moving states of the mobile communication equipment associated with the combination patterns, and registering in advance receiving operation patterns associated with the moving states;
deciding the moving state of the mobile communication equipment on the basis of the positioning detection pattern and vibration detection pattern detected by the positioning sensor and vibration sensor, respectively, at intervals of a predetermined period;
when a call is terminated at the mobile communication equipment, selecting a receiving operation pattern associated with the moving state according to the result of the decision of the moving state; and
designating at least one of the volume of a call termination sound to be generated by the mobile communication equipment and the magnitude of vibration, which are associated with the receiving operation pattern, according to the result of the selection of the receiving operation pattern.

8. The receiving operation control method according to claim 7, wherein a moving speed at which the mobile communication equipment moves is calculated based on a plurality of positioning detection patterns detected by the positioning sensor at different time instants.

9. A computer-readable storage medium for storing a program that, assuming that moving states of a mobile communication equipment associated with combination patterns of positioning detection patterns relevant to positions of the mobile communication equipment detected by a positioning sensor incorporated in the mobile communication equipment and vibration detection patterns relevant to levels of vibration detected by a vibration sensor incorporated in the mobile communication equipment are registered in advance, and receiving operation patterns associated with the moving states are registered in advance, allows a computer:
to decide the moving state of the mobile communication equipment on the basis of the positioning detection pattern and vibration detection pattern detected by the positioning sensor and vibration sensor, respectively, when a call is terminated at the mobile communication equipment;
to select a receiving operation pattern associated with the moving state according to the result of the decision of the moving state; and
to designate at least one of the volume of a call termination sound to be generated by the mobile communication equipment and the magnitude of vibration, which are associated with the receiving operation pattern, according to the result of the selection of the receiving operation pattern.

10. A computer-readable storage medium for storing a program that, assuming that moving states of a mobile communication equipment associated with combination patterns of positioning detection patterns relevant to positions of the mobile communication equipment detected by a positioning sensor incorporated in the mobile communication equipment and vibration detection patterns relevant to levels of vibration detected by a vibration sensor incorporated in the mobile communication equipment are registered in advance, and receiving operation patterns associated with the moving states are registered in advance, allows a computer:
to decide the moving state of the mobile communication equipment on the basis of the positioning detection pattern and vibration detection pattern, which are detected by the positioning sensor and vibration sensor, respectively, at intervals of a predetermined period;
to select a receiving operation pattern associated with the moving state according to the result of the decision of the moving state, when a call is terminated at the mobile communication equipment; and
to designate at least one of the volume of a call termination sound to be generated by the mobile communication equipment and the magnitude of vibration, which are associated with the receiving operation pattern, according to the result of the selection of the receiving operation pattern.
